(19) United States
(12) Patent Application Publication
(10) Pub. No.: US 2012/0265516 A1
(43) Pub. Date: Oct. 18, 2012

(54) PERIPHERAL DEVICE SIMULATION

(75) Inventors: Vamsee Ark, Hyderabad (IN); Deepak Raghuraman Aravindakshan, Hyderabad (IN); Corrina Black, Snohomish, WA (US); Pankaj Kachrulal Sarda, Hyderabad (IN); Gaurav Sisodia, Hyderabad (IN); Satyanarayana Reddy Duggempudi, Hyderabad (IN); Madhu Vadlapudi, Hyderabad (IN)

(73) Assignee: Microsoft Corporation, Redmond, WA (US)

(21) Appl. No.: 13/116,029

(22) Filed: May 26, 2011

Related U.S. Application Data
(60) Provisional application No. 61/474,398, filed on Apr. 12, 2011.

(51) Int. Cl. G06G 7/62

(52) U.S. Cl. 703/21

(57) ABSTRACT

An application can be run in an environment on a host machine. The environment can simulate a machine of a different type from the host machine. A series of events can be received from user input. The series of events can simulate a series of input from a target type of physical peripheral device that is different from a type of physical device used to provide the input. The series of events can be provided to the application for processing, and results of the application processing the series of events can be displayed.

### RELATED APPLICATIONS

This application claims priority to U.S. Provisional Patent Application No. 61/474,398, filed Apr. 12, 2011, entitled PERIPHERAL DEVICE SIMULATION, which is incorporated herein by reference.

### BACKGROUND

Computer applications can be developed for use with target types of computing machines having particular type(s) of peripheral device(s). It can be useful to develop such applications on other types of development machines that may not have those types of peripheral devices. For example, applications may be developed for mobile handheld devices, and those applications may use input from peripheral devices that are common on such handheld devices, such as cameras, orientation sensors (e.g., accelerometers), and global positioning system sensors. As part of development, development machines, such as desktop machines running development software, can be used to simulate the running of the application being developed. For example, the application may be run in a virtual environment hosted on the development machine, where the virtual environment simulates the target type of machine.

### SUMMARY

Development machines may lack some target type of peripheral device with which an application being developed will interact when the application is run on a target type of machine. This can make it difficult to simulate the application's interaction with the target type of device. The tools and techniques described herein are directed to simulating input from target types of physical peripheral devices when an application is being run in a simulation environment. As used herein, a target type of physical peripheral device is a type of physical device that can provide input to the application when the application is run on a target machine. Such target types of physical devices could also perform other functions, such as receiving and responding to output from the application.

In one embodiment, the tools and techniques can include running an application in an environment on a host machine. The environment can simulate a machine of a different type from the host machine. A series of events can be received from user input. The series of events can simulate a series of input from a target type of physical peripheral device that is different from a type of physical device used to provide the input. As used herein an event is a data unit representing user input. An event could be any of various different types of data units, such as input data representing a location, input data representing a movement of a machine, etc. The events may be converted to different forms as they are received and provided to the application. The series of events can be provided to the application for processing, and results of the application processing the series of events can be displayed.

In another embodiment of the tools and techniques, an application can be run in a virtual environment on a host machine, and the virtual environment can simulate a machine of a different type from the host machine. A user can be provided with a tool that allows the user to provide user input including a series of events. The series of events can simulate a series of input from a target type of a physical peripheral device that is different from a type of physical device used to provide the user input. The user input that includes the series of events can be received by the tool, and the tool can provide the series to the application for processing. Results of the application processing the series of events can be displayed using the tool. Additionally, the tool can display a visual illustration of the series of events in a live manner with receiving the events from user input. The visual illustration can be an illustration that does not depend on the application processing of the series of events. As used herein, displaying in a live manner with receiving the user input means that the corresponding illustration for each event in the series is displayed automatically in response to receiving the user input indicating that event, without requiring additional user input beyond the user input indicating that event. The tool may also provide the series of events to the application in a live manner. Accordingly, the input can be provided to the application and the visual illustration can be displayed while the series of events are still being provided by user input.

This Summary is provided to introduce a selection of concepts in a simplified form. The concepts are further described below in the Detailed Description. This Summary is not intended to identify key features or essential features of the claimed subject matter, nor is it intended to be used to limit the scope of the claimed subject matter. Similarly, the invention is not limited to implementations that address the particular techniques, tools, environments, disadvantages, or advantages discussed in the Background, the Detailed Description, or the attached drawings.

### BRIEF DESCRIPTION OF THE DRAWINGS

FIG. 1 is a block diagram of a suitable computing environment in which one or more of the described embodiments may be implemented.

FIG. 2 is schematic diagram of a peripheral device simulation system.

FIG. 3 is an illustration of a handheld mobile machine and an illustration of axes in relation to the machine.

FIG. 4 is an illustration of a peripheral device simulation user interface display with an accelerometer tab selected.

FIG. 5 is another illustration of the peripheral device simulation user interface display with a location tab selected.

FIG. 6 is a flowchart of a peripheral device simulation technique.

FIG. 7 is a flowchart of another peripheral device simulation technique.

FIG. 8 is a flowchart of yet another peripheral device simulation technique.

### DETAILED DESCRIPTION

Embodiments described herein are directed to techniques and tools for simulating input from a type of peripheral device, even though the input may not be provided from that type of peripheral device. Such improvements may result from the use of various techniques and tools separately or in combination.

Such techniques and tools may include providing a tool by which a user can provide input that simulates input from a target type of peripheral device. The tool can also display the results of that input being processed by an application running in a simulation environment. For example, these tools and techniques may be useful for developing applications for handheld mobile devices, such as smart phones. Machines being used for application development often do not have the physical peripheral devices that exist on the phones that are the target type of machine for the application. In simulating the running of the application during development, input techniques such as those discussed more below can be used to allow a user to provide input, and that input can be used to simulate the kind of input that would be expected from the target types of peripheral devices on the phones. For example, the input could be a series of events, such as a series of global positioning coordinates (to simulate a global positioning system sensor), accelerometer readings, etc. Additionally, the results of the application processing that input can be displayed. For example, this may allow a developer to provide user input (such as by using a computer mouse), and see the behavior of the application in a simulation environment (such as a virtual environment). In some examples, values from the user input may be saved and played back later. In other examples, the results of the application processing the input may be provided to the application for processing in a live manner with the input.

Accordingly, one or more substantial benefits can be realized from the peripheral device simulation tools and techniques described herein. For example, the tools and techniques may allow a developer to see how the application reacts to the type of input provided from the simulated type of peripheral device, even if the development machine that is hosting the computer application does not have such a device.

The subject matter defined in the appended claims is not necessarily limited to the benefits described herein. A particular implementation of the invention may provide all, some, or none of the benefits described herein. Although operations for the various techniques are described herein in a particular, sequential order for the sake of presentation, it should be understood that this manner of description encompasses rearrangements in the order of operations, unless a particular ordering is required. For example, operations described sequentially may in some cases be rearranged or performed concurrently. Moreover, for the sake of simplicity, flowcharts may not show the various ways in which particular techniques can be used in conjunction with other techniques.

Techniques described herein may be used with one or more of the systems described herein and/or with one or more other systems. For example, the various procedures described herein may be implemented with hardware or software, or a combination of both. For example, dedicated hardware implementations, such as application specific integrated circuits, programmable logic arrays and other hardware devices, can be constructed to implement at least a portion of one or more of the techniques described herein. Applications that may include the apparatus and systems of various embodiments can broadly include a variety of electronic and computer systems. Techniques may be implemented using two or more specific interconnected hardware modules or devices with related control and data signals that can be communicated between and through the modules, or as portions of an application-specific integrated circuit. Additionally, the techniques described herein may be implemented by software programs executable by a computer system. As an example, implementations can include distributed processing, component/object distributed processing, and parallel processing. Moreover, virtual computer system processing can be constructed to implement one or more of the techniques or functionality, as described herein.

### I. Exemplary Computing Environment

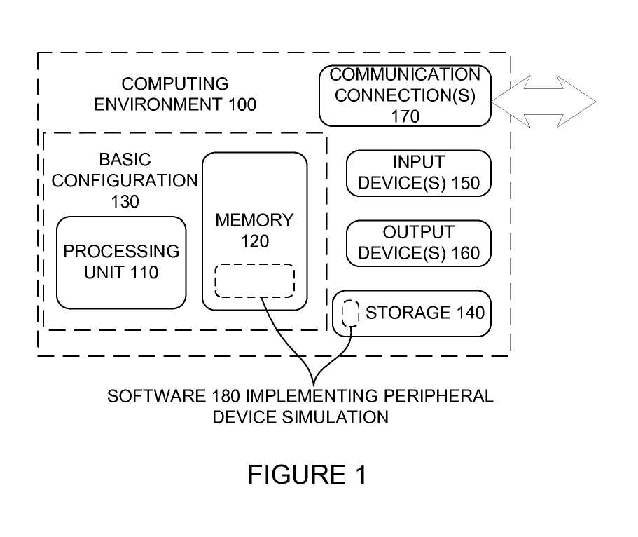

FIG. 1 illustrates a generalized example of a suitable computing environment (100) in which one or more of the described embodiments may be implemented. For example, one or more such computing environments can be used as a development machine for an application, or for a target machine. Generally, various different general purpose or special purpose computing system configurations can be used. Examples of well-known computing system configurations that may be suitable for use with the tools and techniques described herein include, but are not limited to, server farms and server clusters, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

The computing environment (100) is not intended to suggest any limitation as to scope of use or functionality of the invention, as the present invention may be implemented in diverse general-purpose or special-purpose computing environments.

With reference to FIG. 1, the computing environment (100) includes at least one processing unit (110) and at least one memory (120). In FIG. 1, this most basic configuration (130) is included within a dashed line. The processing unit (110) executes computer-executable instructions and may be a real or a virtual processor. In a multi-processing system, multiple processing units execute computer-executable instructions to increase processing power. The at least one memory (120) may be volatile memory (e.g., registers, cache, RAM), non-volatile memory (e.g., ROM, EEPROM, flash memory), or some combination of the two. The at least one memory (120) stores software (180) implementing peripheral device simulation.

Although the various blocks of FIG. 1 are shown with lines for the sake of clarity, in reality, delineating various components is not so clear and, metaphorically, the lines of FIG. 1 and the other figures discussed below would more accurately be grey and blurred. For example, one may consider a presentation component such as a display device to be an I/O component. Also, processors have memory. The inventors hereof recognize that such is the nature of the art and reiterate that the diagram of FIG. 1 is merely illustrative of an exemplary computing device that can be used in connection with one or more embodiments of the present invention. Distinction is not made between such categories as “workstation,” “server,” “laptop,” “handheld device,” etc., as all are contemplated within the scope of FIG. 1 and reference to “computer,” “computing environment,” or “computing device.”

A computing environment (100) may have additional features. In FIG. 1, the computing environment (100) includes storage (140), one or more input devices (150), one or more output devices (160), and one or more communication connections (170). An interconnection mechanism (not shown) such as a bus, controller, or network interconnects the components of the computing environment (100). Typically, operating system software (not shown) provides an operating environment for other software executing in the computing environment (100), and coordinates activities of the components of the computing environment (100).

The storage (140) may be removable or non-removable, and may include computer-readable storage media such as magnetic disks, magnetic tapes or cassettes, CD-ROMs, CD-RWs, DVDs, or any other medium which can be used to store information and which can be accessed within the computing environment (100). The storage (140) stores instructions for the software (180).

The input device(s) (150) may be a touch input device such as a keyboard, mouse, pen, or trackball; a voice input device; a scanning device; a network adapter; a CD/DVD reader; or another device that provides input to the computing environment (100), such as a global positioning system sensor, an orientation sensor, a compass, etc. The output device(s) (160) may be a display, printer, speaker, CD/DVD-writer, network adapter, or another device that provides output from the computing environment (100).

The communication connection(s) (170) enable communication over a communication medium to another computing entity. Thus, the computing environment (100) may operate in a networked environment using logical connections to one or more remote computing devices, such as a personal computer, a server, a router, a network PC, a peer device or another common network node. The communication medium conveys information such as data or computer-executable instructions or requests in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The tools and techniques can be described in the general context of computer-readable media, which may be storage media or communication media. Computer-readable storage media are any available storage media that can be accessed within a computing environment, but the term computer-readable storage media does not refer to propagated signals per se. By way of example, and not limitation, with the computing environment (100), computer-readable storage media include memory (120), storage (140), and combinations of the above.

The tools and techniques can be described in the general context of computer-executable instructions, such as those included in program modules, being executed in a computing environment on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing environment. In a distributed computing environment, program modules may be located in both local and remote computer storage media. A computing application, or application, includes one or more program modules that can operate together.

For the sake of presentation, the detailed description uses terms like “receive,” “provide,” “display,” and “determine” to describe computer operations in a computing environment. These and other similar terms are high-level abstractions for operations performed by a computer, and should not be confused with acts performed by a human being, unless performance of an act by a human being (such as a “user”) is explicitly noted. The actual computer operations corresponding to these terms vary depending on the implementation.

### II. Peripheral Device Simulation System

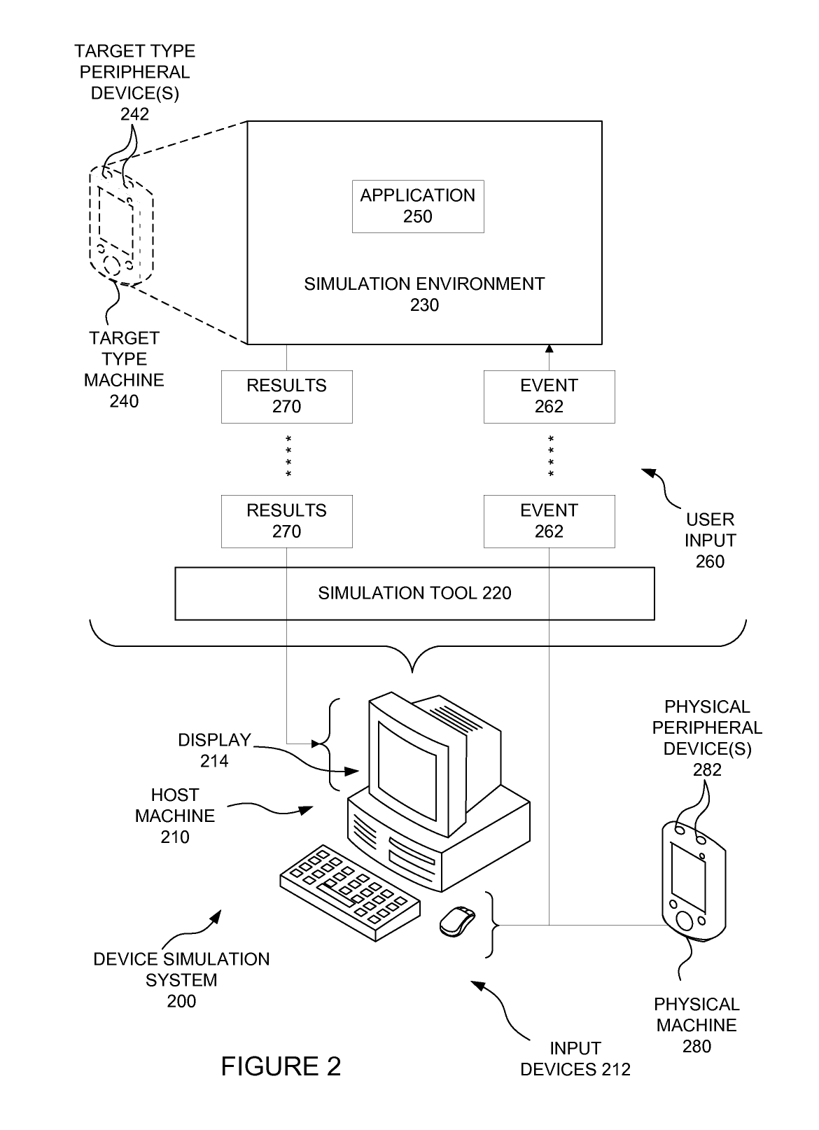

FIG. 2 is a schematic diagram of a peripheral device simulation system (200) in conjunction with which one or more of the described embodiments may be implemented. The system (200) can include a host machine (210), which can be a development machine that a user is using for application development and simulation. The host machine (210) can be a computing environment and include components similar to those discussed above with reference to FIG. 1. For example, the host machine (210) can include input devices (212), such as a mouse, keyboard, trackball, etc. The host machine (210) can also include one or more output devices, such as a display (214). The host machine (210) can run a simulation tool (220), which can prompt the host machine (210) to launch a simulation environment (230), which can be a virtual environment that simulates a target type of machine (240). For example, the simulation environment (230) can simulate target type peripheral devices (242) of the target type of machine (240), such as a global positioning system sensor, an accelerometer, etc. Additionally, an application (250) that is being simulated and/or developed can be launched within the simulation environment (230).

The device simulation system (200) can be configured so that the simulation tool (220) can allow a user to interact with the application (250) in a way that simulates input from the target type peripheral devices (242) of the target machine (240), even if the host machine (210) does not include the same types of peripheral devices. User input (260) that can include a series of events (262) can be provided to the application (250) for processing. Results (270) of the processing can be displayed on the display (214) by the simulation tool (220). The simulation tool (220) may also provide a display of a visual illustration of the series of events (262), which can provide feedback to a user that is providing the user input (260).

A user can provide input through one of the input devices (212) of the host machine (210). Alternatively, input may be provided in some other way. For example, input may be provided to the host machine (210) from a separate physical machine (280) that includes a target type of physical peripheral device (282). For example, the physical machine (280) may be a target type of physical machine (e.g., a smart phone) with a target type of physical peripheral device (282). The physical machine (280) may be connected to the host machine (210) through a wired or wireless connection to provide input. The physical machine (280) may be provided with a software application that collects information and sends it to the host machine (210). As an example, such a software application may be a client application that interacts with the simulation tool (220).

A. Machine Orientation & Accelerometer Example

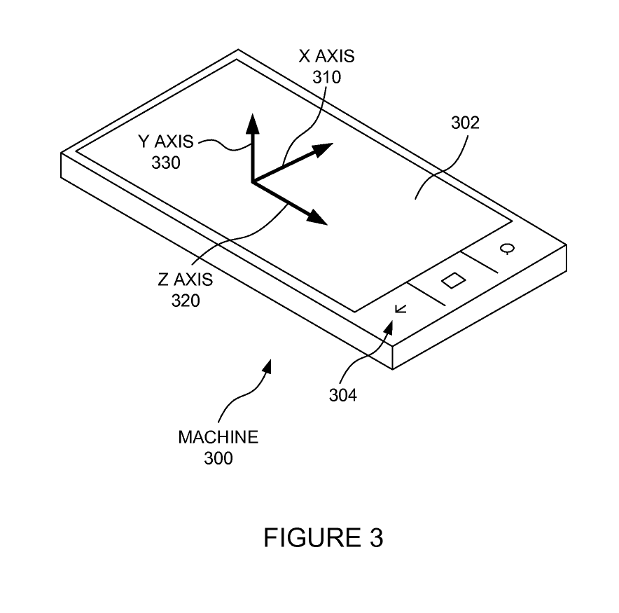

Following is a discussion of an example of a simulation tool simulating a machine orientation peripheral device, such as an accelerometer. Referring to FIG. 3, a handheld mobile machine (300) such as a smart phone is illustrated for purposes of explaining basic concepts related to machine orientation. The machine (300) can include smart phone components such as a display screen (302), control buttons (304), etc. The machine (300) may also include peripheral devices such as an accelerometer sensor (not shown) that can sense orientation of the machine (300), and a global positioning system sensor (not shown) that can sense location of the machine (300).

Changes in the orientation of the machine (300) can be thought of in terms of rotation about three perpendicular axes. For example, these axes may include the following: an X axis (310) that extends across the display screen (302) from left to right when the machine (300) is in a portrait orientation laying on a flat horizontal surface; a Z axis (320) that extends along the display screen (302) toward the base of the machine (300); and a Y axis (330) that extends up from the machine (300) perpendicular to the display screen (302).

Most changes in orientation of the machine (300) can be produced by starting at a known orientation, and then rotating about the X axis (310), the Z axis (320), and other axes within the X-Z plane (the plane that includes the display screen (302)). Using only these combinations, a pure rotation about the Y axis (330) would not be produced. However, rotations about the Y axis (330) could also be supported to produce such rotations.

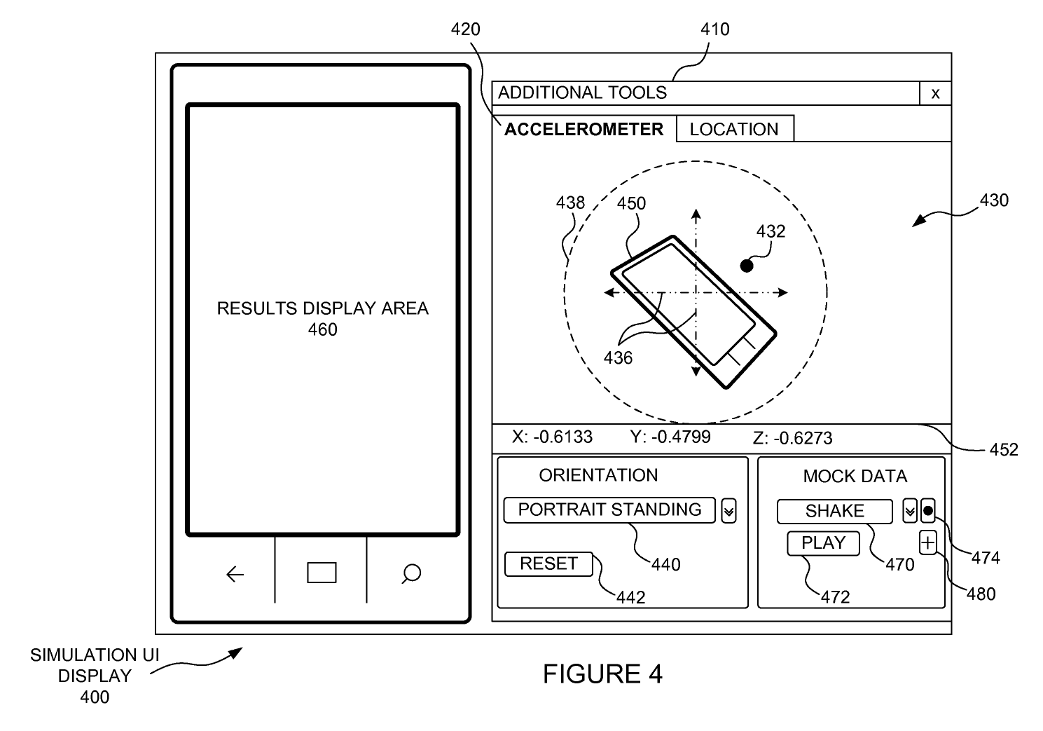

Referring now to FIG. 4, a peripheral device simulation user interface display (400) is illustrated. The display (400) can include an additional tools area (410) on the right side. The additional tools area (410) can include multiple tabs that can be selected to display user interface features for simulating different target types of peripheral devices. In FIG. 4, an accelerometer tab (420) is selected to reveal a rotation input area (430). The rotation input area can include a pointer (432) that can be moved in response to user input (e.g., by dragging with a mouse, moved using keyboard arrow keys, etc.) to produce corresponding simulated machine rotations.

In one implementation, the pointer (432) may be moveable to produce rotation about the X and Z axes and other axes in the X-Z plane. This can simulate movement for many applications that use accelerometer data as inputs. Rotation about the X or Z axes can be produced by moving the pointer (432) along one of the displayed axes (436) (the axes (436) may or may not be shown in the rotation input area (430)). Rotation about other axes in the X-Z plane can be produced by moving the pointer (432) along an arbitrary axis in the rotation input area (430). Movement of the pointer (432) may be restricted to a circular area (438) of the rotation input area (430). If user input attempts to move the pointer (432) outside the circular area (438), then the pointer (432) can move along a circumference of the circular area (438).

A starting, or default, orientation can be specified in a default orientation area (440) of the rotation input area (430). The default orientation area (440) can produce a drop-down menu for selecting different default orientations. For example, user input may choose between portrait standing (portrait in a vertical plane), landscape standing (landscape in a vertical plane), portrait flat (portrait in a horizontal plane), and landscape flat (landscape in a horizontal plane). This can produce an initial default starting orientation at the default. Additionally, a reset button (442) can be selected by user input to bring the orientation back to the default specified in the default orientation area (440).

A current orientation can be represented by displaying a visual orientation illustration (450) of an oriented machine. This orientation illustration (450) can be overlaid in the same area where the pointer (432) is being operated, as shown in FIG. 4. Alternatively, the orientation illustration (450) could be displayed in some other area. The orientation illustration (450) can provide feedback to a user as to the effect of rotational movements, such as rotations produced by movement of the pointer (432).

In computing the rotation produced by movements of the pointer (432), a current position of the pointer (432) can be captured. A displacement (DeltaDisp) of the pointer (432) from the origin can be computed. A total displacement (TotalDisp) from the origin to an edge of the circular area (438) on the same line as the displacement can be computed as well. A vector perpendicular to the displacement vector can be found (the AxisofRotation). An angle of the rotation can be calculated as ((DeltaDisp)/(TotalDisp))*90, and a direction of rotation can be based on the displacement vector being positive or negative. Accelerometer values can be calculated based on the calculations of the displacement vector, angle of rotation, and direction of rotation. These accelerometer values can be continuously displayed, such as in a status bar (452) at the bottom of the rotation input area (430). A new orientation can be produced by rotating the machine about the AxisofRotation by the angle of rotation. A movement from an initial orientation to a final rotation can be displayed as a smooth transition of the orientation illustration (450).

In addition to making changes to the orientation illustration (450), these orientation changes can be communicated as a series of events to an application that is being simulated. For example, the calculated accelerometer values can be communicated to a module simulation an accelerometer in a virtual environment in which the application is running. The values may be converted so that they are properly formatted and mapped for the virtual environment in which the application is running. The application can process such values and return the results of the processing, so that the results of the processing can be displayed in a results display area (460). This results display area (460) can be displaying what a target type device would be displaying if the input events (e.g., the accelerometer values) were received from a target type physical peripheral device (e.g., an accelerometer) and processed by the application on such a target type device (e.g., a physical smart phone).

The orientation feedback provided by the orientation illustration (450) and the results display area (460) can be provided in a live manner with the input that moves the pointer (432) to produce rotational movements. Thus, a user can receive live feedback on the results of the application processing the rotational movements (e.g., by processing a series of accelerometer values). As an example, the orientation illustration (450) may be updated and accelerometer data may be displayed and fed to the application at a set interval, such as every 40 milliseconds.

Rather than providing the accelerometer data in a live manner as discussed above, files can be played to produce sequences of rotations. For example, pre-canned files may be provided to produce popular accelerometer gestures, such as shake (shaking the machine left and right quickly), tilt, or spin. Referring still to FIG. 4, a mock data name area (470) can be used to specify a file to be played (either a pre-canned file that is provided or a file that has previously been recorded). The play button (472) can be selected to play the file specified in the mock data name area (470), resulting in a series of rotation events from the file being input, as with live input provided by moving the pointer (432). A user may be provided with options to provide user input to control an in-progress series being played, such as by stopping, pausing, or repeating the rotation series.

A series of rotations may be recorded by selecting a record button (474), and then moving the pointer (432) to provide input. The input may be saved in any of various forms, such as indications of locations of the pointer (432), accelerometer values, etc. Such a recorded series can be played back, as discussed above.

Additionally, a series of input events can be captured from a machine that has an accelerometer, and the series can be recorded (and played back later, as discussed above). For example, the plus button (480) in the mock data area can be selected to surface a menu that includes an entry for capturing the mock data from a separate machine. The separate machine can be connected to the host machine, and a data collection agent can be loaded on the separate machine. The user can then select an option to begin recording, and the agent can capture accelerometer data as it is produced on that separate machine. The agent can also send the data to the host machine, where the data can be saved (possibly after being converted to a different form for saving). The saved data can then be loaded and used later, such as by selecting the associated file from a drop-down menu or browsing to the file.

B. Location & Global Positioning System Sensor Example

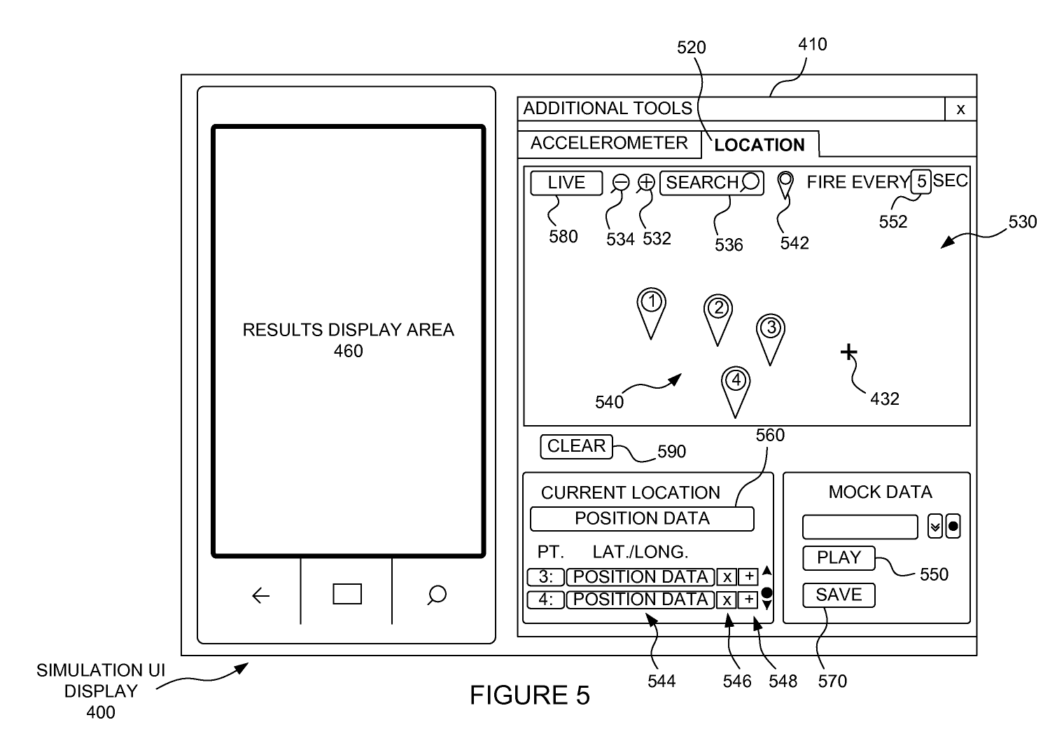

Following is a discussion of an example of a simulation tool simulating a global positioning sensor peripheral device. Referring now to FIG. 5, the simulation user interface display (400) is shown, but with a location tab (520) selected in the additional tools area (410). Selection of the location tab (520) can reveal an interactive map (530) (details of the map itself are not show in FIG. 5, but could include map features, which could include but are not limited to illustrations of features such as roads, paths, topographical information, railways, names of geographical regions, etc.

As with the rotation input area (430), the pointer (432) can be used within the interactive map (530) to provide input, although the pointer (432) may appear and operate differently. For example, the pointer can be used to navigate the interactive map (530). For example, panning the map (530) may be indicated by holding down a key (e.g., a left mouse button) and moving in a direction, which can indicate that the map (530) is to be dragged in that direction. While panning, the appearance of the pointer (432) may change (e.g., to a hand holding the screen) to indicate to a user that panning mode is active. Additionally, zooming may be accomplished by providing input, such as selecting a zoom-in button (532) to zoom in and a zoom-out button (534) to zoom out. Search terms can be input to a search box (536) to search the map (530) for a given location, such as searching for a particular address, city, or other point or area of interest. In response, the map (530) can be updated with the indicated location at the center of the map. In one implementation, searching for a location can change the current area of the map (530) that is displayed, without deleting a sequence of points already indicated on the map. If there is more than one location that matches specified search criteria, the map (530) can automatically be adjusted with the highest ranking result as the center of the map (530). Alternatively, a list of the matching locations may be displayed, so that user input can be provided to choose between the matching locations.

User input can be provided to choose a series of location points to be simulated. For example, points may be represented as pins (540) on the map (530). As illustrated, each pin (540) may have a number, with the numbers indicating a sequence for the corresponding series of location points. A pin adding mode may be activated by selecting a pin button (542). In this mode, the pointer (432) can change appearance to indicate to a user that the pin adding mode is active. For example, the pointer (432) may appear in the shape of the pins (540) that are added to the map (530). While in this mode, the pointer (432) can be moved to a desired location and selected (e.g., with a mouse click) to place a pin (540) at the location of the pointer (432). Multiple pins (540) can be added by selecting more locations, and the pins (540) can be labeled (such as with numbers as illustrated) to represent the sequence in which the pins (540) were added. When a pin (540) is added, an entry for the location can be added in a point data area (544).

Each entry in the point data area (544) can include a designation of the label for the point, position data for the point (e.g., latitude and longitude coordinates), and operating buttons related to the point. For example, each entry may include a removal button (546) with an X for removing the entry and the corresponding pin (540). In addition to or instead of such a removal button (546), some other mechanism may be provided for removing entries (right clicking on the pin (540) and selecting a removal option, etc.). When a pin (540) is removed, the remaining pins (540) and corresponding entries may be relabeled (unless the removed pin is the last in the series). Additionally, an add button (548) with a + symbol may be selected to add another entry and corresponding pin (540) after the current one. For example, user input may select an add button (548), then press the pin button (542), followed by selecting a location on the map with the pointer (432) to add the new pin (540) and to add (548) a corresponding entry in the point data area (544). Other operating buttons may also be provided for the entries in the point data area (544). For example, up and down buttons may be included to allow user input to change the order of the locations that have already been entered, etc.

The current set of points can be played by selecting a play button (550). This can result in the points being fed into the environment for the application being run in sequence, with a specified time interval between the points. The results from the application processing these points can be displayed in the results display area (460) with the timing of the points being provided to the application. The time interval between points can be specified from user input in an interval box (552). A default interval may be used if no value is specified in the interval box (552), such as one second, two seconds, or five seconds. Additionally, different time intervals may be specified between different points. Location data may be provided to the application in shorter intervals than the time interval between points, so that each point may be provided multiple times to the application, or interpolations between points (possibly along specified routes, such as roads on a map) may be provided. When a play back is done, the map (530) can remain focused on a last point that was played, and data for that point may continue to be fed to the application as long as the playback session continues. A user can control the session using controls such as pause and stop buttons, etc. During playback, position data (e.g., latitude and longitude coordinates) for a current location can be shown in a status bar (560). Errors, if any, related to the global positioning system could also be displayed in the status bar (560), or in the general area of the status bar (560).

User input can be provided to save a given sequence of points in a file with a given name so that the file can be played back later. For example, a save button (570) can be selected, and this selection can cause a screen to be surfaced, where user input can be provided to specify a file name and location for saving the file. Additionally, user input can be provided to select a previously saved series of points, which can be done by specifying a file location and name, as with a previously-saved file being loaded for orientation data discussed above. The last five files that were loaded can be displayed for selection, and a user can browse to select other files. User input can select the play button (550), which can result in the specified sequence of points being played.

In addition to points being played, user input can be provided to send location data in a live manner to the application, so that the results of the application processing the location data can be displayed in a live manner with the input in the results display area (460). User input can be provided at a live button (580) to enter the live mode. In the live mode, when user input is provided to select a location on the map (530) (e.g., clicking on the map (530)), the point can be sent to the application as a global positioning system location update. The series of points selected while in live mode may be saved by providing an input selection at the save button (570) (i.e., by selecting the save button). The series of points entered while in live mode can be maintained while in live mode, and when live mode is exited those points can be maintained. User input may also be provided to modify the series of points (removing, changing the sequence, adding new points between other points in the sequence, etc.). Also, when live mode is switched on, if a series of points is already being maintained, those points can still be maintained, with the new points entered in live mode being appended to the end of the series.

In one or more of the modes, the location points being maintained may be cleared in response to user input. For example, a “clear” button (590) may be selected by user input. This may also clear information about files that have been selected for loading and playing.

Besides the location and orientation peripheral device simulations discussed above, simulations of other types of devices may also be performed in similar ways, by collecting data using peripheral devices other than those target types of peripheral devices, and mapping the resulting data to data that simulates data from the physical devices.

### III. Peripheral Device Simulation Techniques

Several peripheral device simulation techniques will now be discussed. Each of these techniques can be performed in a computing environment. For example, each technique may be performed in a computer system that includes at least one processor and at least one memory including instructions stored thereon that when executed by the at least one processor cause the at least one processor to perform the technique (one or more memories store instructions (e.g., object code), and when the processor(s) execute(s) those instructions, the processor(s) perform(s) the technique). Similarly, one or more computer-readable storage media may have computer-executable instructions embodied thereon that, when executed by at least one processor, cause the at least one processor to perform the technique.

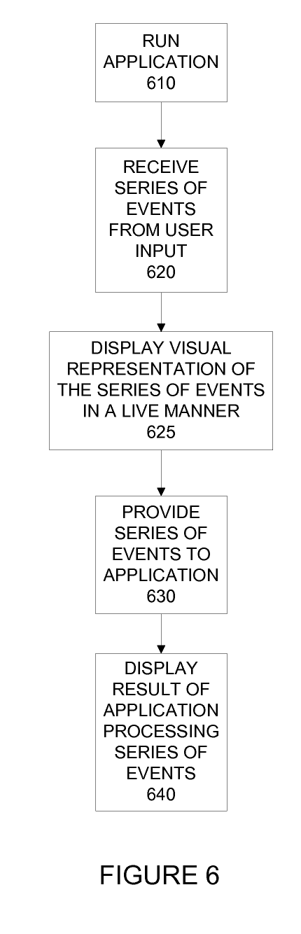

Referring to FIG. 6, a peripheral device simulation technique will be described. The technique can include running (610) an application in an environment on a host machine, with the environment simulating a machine of a different type from the host machine. For example, the host machine may be a laptop or desktop computer and the handheld device may be a smart phone or other handheld mobile device. A series of events can be received (620) from user input. The series of events can simulate a series of input from a target type of physical peripheral device that is different from a type of physical device used to provide the input. For example, the target type of physical peripheral device may be selected from a group consisting of a location sensor, an orientation sensor, and combinations thereof. Examples of types of physical devices used to provide input could include, for example, a mouse, a trackball, a keyboard, a touch screen, a microphone, or combinations thereof.

A visual illustration of the series of events can be displayed (625) with receiving the events from user input. Additionally, the series of events can be provided (630) to the application for processing. Results of the application processing the series of events can be displayed (640). The visual illustration may be an illustration that does not depend on the application processing the series of events.

As an example, the target type of physical peripheral device can include an orientation sensor (e.g., an accelerometer), and the series of events can represent a series of orientation changes to the target type of machine. The visual illustration can include a display of an orientation of the target of machine resulting from the series of orientation changes. As another example, the target type of physical peripheral device can be a location sensor, and the series of events can represent a series of locations. The visual illustration can include a display of a map with indications of at least a portion of the locations in the series of locations.

At least part of displaying (640) the results can be done while receiving (620) the series of events from user input. Thus, a time period within which the results are displayed (640) can overlap with a time period within which the series of events are received (620). Similarly, at least part of displaying (640) the results may be done while providing (630) the series of events to the application. Receiving (620) the series of events from user input may include saving the series of events to a file, and providing (630) the series of events to the application can include reading the events from the file.

Receiving (620) the series of events from user input can include providing a user with a tool that allows the user to provide the user input and that displays the results. Receiving (620) the series of events from user input may include storing the events before providing the series of events to the application, and providing (630) the series of events to the application for processing can include reading the events from storage. The host machine may not include the target type of physical peripheral device, and receiving (620) the series of events from user input may include receiving the series of events from a machine having the type of physical peripheral device. For example, a smart phone connected to the host machine may provide the series of events to the host machine.

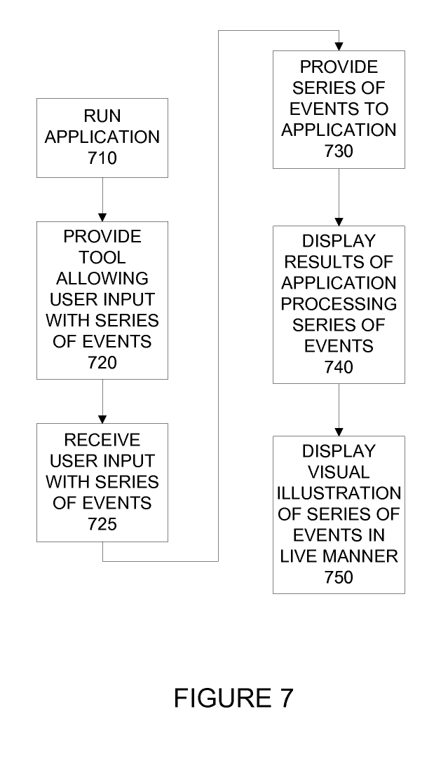

Referring to FIG. 7, another peripheral device simulation technique will be described. The technique can include running (710) an application in a virtual environment on a host machine. The virtual environment can simulate a machine of a different type from the host machine. The technique can also include providing (720) a user with a tool that allows the user to provide user input that includes a series of events. The series of events can simulate a series of input from a target type of physical peripheral device different from a type of physical device used to provide the user input. User input that includes the series of events can be received (725) by the tool, and the tool can provide (730) the series of events to the application for processing. Results of the application processing the series of events can be displayed (740) using the tool. The displaying (740) of the results can be done in a live manner with receiving the user input. The technique of FIG. 7 may further include the tool displaying (750) a visual illustration of the series of events in a live manner with receiving the user input including the events. The visual illustration may be an illustration that does not depend on the application processing the series of events. The visual illustration may include an illustration selected from a group consisting of an illustration selected from a group consisting of an interactive display including an orientation of a machine resulting from a series of orientation changes, and an interactive display including a map with indications of one or more locations in a series of locations.

Referring still to the technique of FIG. 7, the user input can include selections of points on a displayed map, and the target type of physical peripheral device can include a location sensor. The user input may include indications to move the pointer to simulate rotational movement, and the target type of physical peripheral device may include an orientation sensor, such as a global positioning system sensor. The user input may include indications to move the pointer to simulate rotational movement about multiple axes, and the target type of physical peripheral device may include an accelerometer.

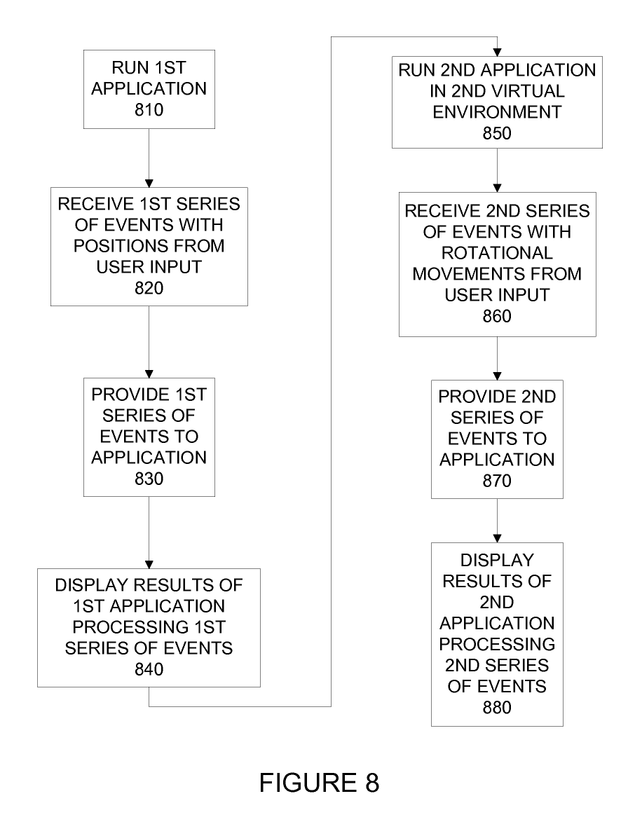

Referring to FIG. 8, yet another peripheral device simulation technique will be described. The technique can include running (810) a first application in a first virtual environment on a host machine. The first virtual environment can simulate a first target type of handheld machine of a different type from the host machine. A first series of events can be received (820) from user input. The first series of events can represent positions simulating a series of positions from a location sensor, and the input for the first series of events can include location selections on a displayed map. The first series of events can be provided (830) to the first application for processing in a live manner in response to the user input for the first series of events. Here, a live manner has the same meaning as the meaning discussed above with reference to displaying in a live manner. The results of the first application processing the first series of events can be displayed (840).

A second application can be run (850) in a second virtual environment on the host machine. The second virtual environment can simulate a second target type of handheld machine of a different type from the host machine. The first and second environments could be the same environment that hosts the first application and then later hosts the second application. Also, the first target type of handheld machine may be the same type of handheld machine as the second target type of handheld machine. For example, the target type of machine may be a machine having a global positioning system sensor and an accelerometer. A second series of events can be received (860) from user input. The second series of events can represent rotational movements that simulation rotational movements from an orientation sensor. The input for the second series of events can include indications to move a pointer to simulate rotational movement. The second series of events can be provided (870) to the second application for processing in a live manner in response to the user input for the second series of events. Results of the second application processing the second series of events can be displayed (880).

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

I/We claim:

1. A computer-implemented method, comprising:
running an application in an environment on a host machine, the environment simulating a target type of machine of a different type from the host machine;
receiving a series of events from user input, the series of events simulating a series of input from a target type of physical peripheral device different from a type of physical device used to provide the input;
providing the series of events to the application for processing; and
displaying results of the application processing the series of events.

2. The method of claim 1, further comprising displaying a visual illustration of the series of events in a live manner with receiving the events from user input, the visual illustration not depending on the application processing the series of events.

3. The method of claim 2, wherein the target type of physical peripheral device comprises an orientation sensor, the series of events represents a series of orientation changes to the target type of machine, and the visual illustration comprises a display of an orientation of the target type of machine resulting from the series of orientation changes.

4. The method of claim 2, wherein the target type of physical peripheral device is a location sensor, the series of events represents a series of locations, and the visual illustration comprises a display of a map with indications of at least a portion of the locations in the series of locations.

5. The method of claim 1, wherein at least part of displaying the results is done while receiving the series of events from user input.

6. The method of claim 1, wherein at least part of displaying the results is done while providing the series of events to the application.

7. The method of claim 1, wherein receiving the series of events from user input comprises providing a user with a tool that allows the user to provide the user input and that provides the series of events to the application in a live manner in response to the user input.

8. The method of claim 1, wherein the series of events represents a series of locations.

9. The method of claim 1, wherein the series of events represents a series of orientation changes.

10. The method of claim 1, wherein the machine of the different type is a handheld device.

11. The method of claim 1, wherein the target type of physical peripheral device is selected from a group consisting of a location sensor, an orientation sensor, and combinations thereof.

12. The method of claim 1, wherein receiving the series of events from user input comprises storing the series of events before providing the series of events to the application, and wherein providing the series of events to the application for processing comprises reading the events from storage.

13. The method of claim 1, wherein the host machine does not include the target type of physical peripheral device, and wherein receiving the series of events from user input comprises receiving the series of events from a machine having the type of physical peripheral device.

14. A computer system comprising:
at least one processor; and
at least one memory comprising instructions stored thereon that when executed by the at least one processor cause the at least one processor to perform acts comprising:
running an application in a virtual environment on a host machine, the virtual environment simulating a machine of a different type from the host machine;
providing a user with a tool that allows the user to provide user input comprising a series of events, the series of events simulating a series of input from a target type of a physical peripheral device different from a type of physical device used to provide the user input;
the tool receiving the user input comprising the series of events;
the tool providing the series of events to the application for processing;
the tool displaying results of the application processing the series of events; and
the tool displaying a visual illustration of the series of events in a live manner with receiving the user input comprising the series of events, the visual illustration not depending on the application processing the series of events.

15. The computer system of claim 14, wherein the visual illustration comprises an illustration selected from a group consisting of an interactive display including an orientation of a machine resulting from a series of orientation changes, and an interactive display including a map with indications of one or more locations in a series of locations.

16. The computer system of claim 14, wherein the user input comprises selections of points on a displayed map, and wherein the target type of physical peripheral device comprises a location sensor.

17. The computer system of claim 14, wherein the user input comprises indications to move a pointer to simulate rotational movement, and wherein the target type of physical peripheral device comprises an orientation sensor.

18. The computer system of claim 17, wherein the user input comprises indications to move the pointer to simulate rotational movement about multiple axes.

19. The computer system of claim 17, wherein the target type of physical peripheral device comprises an accelerometer.

20. One or more computer-readable storage media having computer-executable instructions embodied thereon that, when executed by at least one processor, cause the at least one processor to perform acts comprising:
running a first application in a first virtual environment on a host machine, the first virtual environment simulating a first target type of handheld machine of a different type from the host machine;
receiving a first series of events from user input, the first series of events representing positions simulating a series of positions from a location sensor, and the input for the first series of events comprising location selections on a displayed map;
providing the first series of events to the first application for processing in a live manner in response to the user input for the first series of events;
displaying results of the first application processing the first series of events;
running second an application in a second virtual environment on the host machine, the second virtual environment simulating a second target type of handheld machine of a different type from the host machine;
receiving a second series of events from user input, the second series of events representing rotational movements simulating rotational movements from an orientation sensor, the input for the second series of events comprising indications to move a displayed pointer to simulate rotational movement;
providing the second series of events to the second application for processing in a live manner in response to the user input for the second series of events; and
displaying results of the second application processing the second series of events.
